(19) United States
(12) Patent Application Publication
(10) Pub. No.: US 2020/0101632 A1
(43) Pub. Date: Apr. 2, 2020

(54) Safety Cutter

(71) Applicant: Acme United Corporation, Fairfield, CT (US)

(72) Inventor: Nicholas L. Seferi, Southbury, CT (US)

(21) Appl. No.: 16/149,475

(22) Filed: Oct. 2, 2018

(51) Int. Cl. B26B 3/08; B26B 9/02; B26B 29/06

(52) U.S. Cl. CPC B26B 3/08; B26B 27/005; B26B 29/06; B26B 9/02

(57) ABSTRACT

A safety cutter adapted to open a box or similar packaging comprises a molded elongated handle which integrally connects with a protective head that mounts a fixed blade. The head extends transversely and has a protective canopy. Exposed portions of the blade, which is preferably ceramic, are protectively disposed at opposed portions of an upper end of the handle below said head. The handle has measurement scales and a contoured thumb grip.

### BACKGROUND

This disclosure relates generally to cutters adapted to open boxes and perform similar tasks. More particularly, this disclosure relates to compact cutters which employ a non-replaceable blade and have a fixed blade protective construction.

A number of related cutter implements have been advanced which have blades that are extendable and retractable or alternatively employ displaceable blade guards. Replaceable blade capability is also common.

In addition, there has been a recent trend toward ceramic-type blades to provide an additional element of safety.

A recurring problem in the technology to which the present disclosure relates is to provide a cutter which is effective, yet has a safe and low cost construction.

### SUMMARY

Briefly stated, a safety cutter comprises a handle having a first end and a second end forming a neck. The handle tapers from the first end to an intermediate location and has a reduced portion between the intermediate location and the second end. A transversely extending head integrally connects the neck. A blade is captured by the head. Portions of the blade are exposed adjacent opposed portions of the neck.

The handle and the head are preferably integrally molded components. The handle is generally symmetric about a medial line and has opposed side portions which are generally linear. An English measurement scale is disposed along one linear side portion, and a metric linear scale is disposed along a second linear side portion. A reduced portion has a bulge portion which protrudes frontally and rearwardly. The bulge portion is traversed by a plurality of ribs. The handle further comprises a medial panel which extends between opposed sides. The panel defines a plurality of circular openings.

The head has a canopy portion which extends forwardly and rearwardly relative to the blade and covers opposed ends of the blade. The blade is preferably a ceramic blade.

A safety cutter comprises a handle comprising a first end and a second end forming a neck and tapering exteriorly from the first end to an intermediate location and having a recess portion between the intermediate location and the second end. A transversely extending head integrally connects the neck so that the handle and the head form a substantially truncated T-shaped profile. A blade is captured by the head and the head covers opposed end portions of the blade. Portions of the blade are exposed adjacent opposed portions of the neck.

The handle and the head are preferably integrally molded components. The handle is generally symmetric about a medial line and has opposed side portions which are generally linear. An English measurement scale and a metric linear scale are disposed along each linear side portion. The recess portion has a bulge portion which protrudes frontally and rearwardly and is traversed by a plurality of ribs. The handle has opposed sides and further comprising a medial panel portion which extends between opposed sides, and the panel defines a plurality of circular template openings.

A safety cutter comprises a handle comprising a first end and a second end and having opposed sides uniformly tapering from the first end to an intermediate location. The handle has a reduced portion between the intermediate location and the second end. A transversely extending head integrally connects the handle. A blade is captured by the head wherein spaced portions of the blade are exposed adjacent opposed portions of the handle and opposed end portions of the blade are covered by the head.

A handle and the head are integrally molded components and the handle and the head are generally symmetric relative to central orthogonal planes. Opposed side portions are generally linear. An English measurement scale and a metric measurement scale are disposed along one linear side portion. The reduced portion has a bulge portion which protrudes frontally and rearwardly. The head forms an arcuate canopy which extends forwardly and rearwardly and beyond end portions of the blade to define a pair of access slots leading to exposed portions of the blade.

### BRIEF DESCRIPTION OF THE DRAWINGS

FIG. 1 is a perspective view of a safety cutter;

FIG. 2 is an opposite side perspective view of the safety cutter of FIG. 1;

FIG. 3 is a front view of the safety cutter of FIG. 1;

FIG. 4 is a rear view of the cutter of FIG. 3;

FIG. 5 is a right side view of the safety cutter of FIG. 3;

FIG. 6 is a left side view of the safety cutter of FIG. 3;

FIG. 7 is an enlarged top plan view of the safety cutter of FIG. 3;

FIG. 8 is an enlarged bottom plan view, partly diagrammatic, of the safety cutter of FIG. 3; and

FIG. 9 is an enlarged fragmentary exploded view, partly diagrammatic, illustrating one embodiment of a manufacturing process for the safety cutter of FIG. 1.

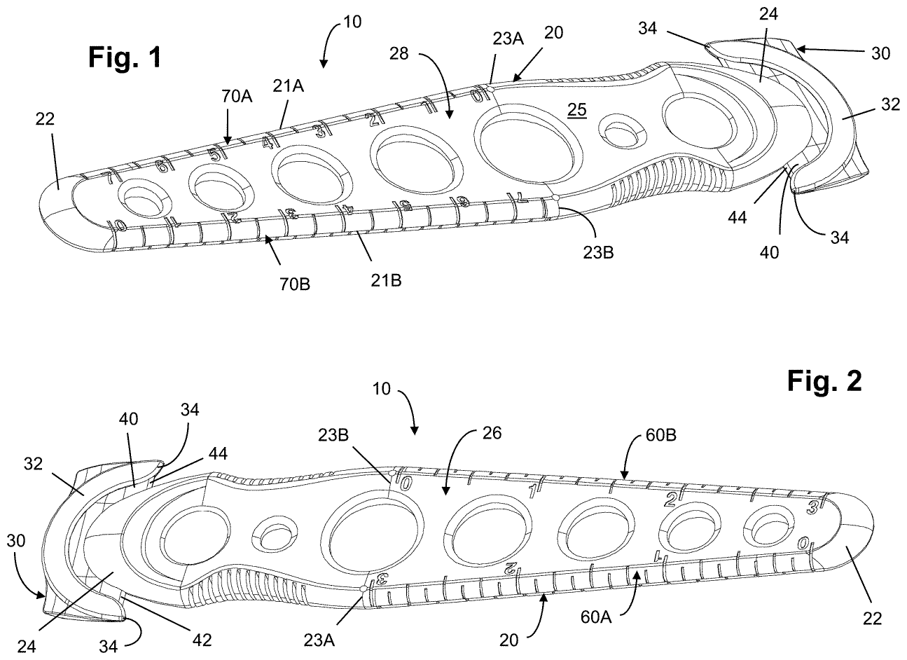

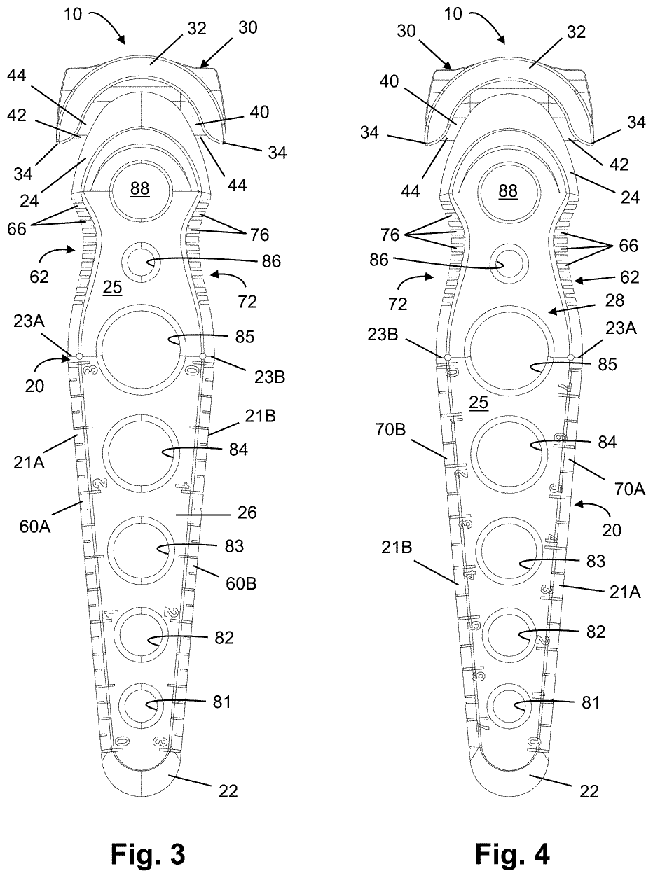

### DETAILED DESCRIPTION

With reference to the drawings wherein like numerals represent like parts throughout the figures, a safety cutter is generally designated by the numeral 10. Safety cutter 10 is particularly adapted for opening boxes and similar packaging and has a low-cost construction with a protective fixed blade mount. The safety cutter 10 is easy to use and is multi-functional.

The cutter 10 has a generally truncated T-shaped profile comprising an elongated handle 20, a transverse head 30 and a captured fixed blade 40. Except for measurement scales described below, the handle 20 and head 30 are generally symmetric about planes P and Q which are perpendicular along medial line L (see FIG. 8). The handle 20 which extends from a rounded lower first end 22 in a generally symmetrical multi-contoured fashion toward an upper second end 24. The end 24 forms a neck which integrally connects a medial location of a transversely extending protective head 30. The protective head cooperates to mount or capture a ceramic blade 40. Alternatively, the blade may be a steel blade. Except for the blade, the safety cutter 10 is entirely formed from molded material and essentially has a one-piece integral construction.

The handle 20 has a uniform tapered dual side structure 21A and 21B which uniformly tapers from the rounded first end 22 toward an intermediate portion 23A and 23B on transversely opposed sides of the handle. The handle has a front 26 and a rear 28. The opposed sides 21A and 21B define a generally straight linear portion with English measurement scales 60A and 60B on the front 26 and side and metric scales 70A and 70B on the rear side 28.

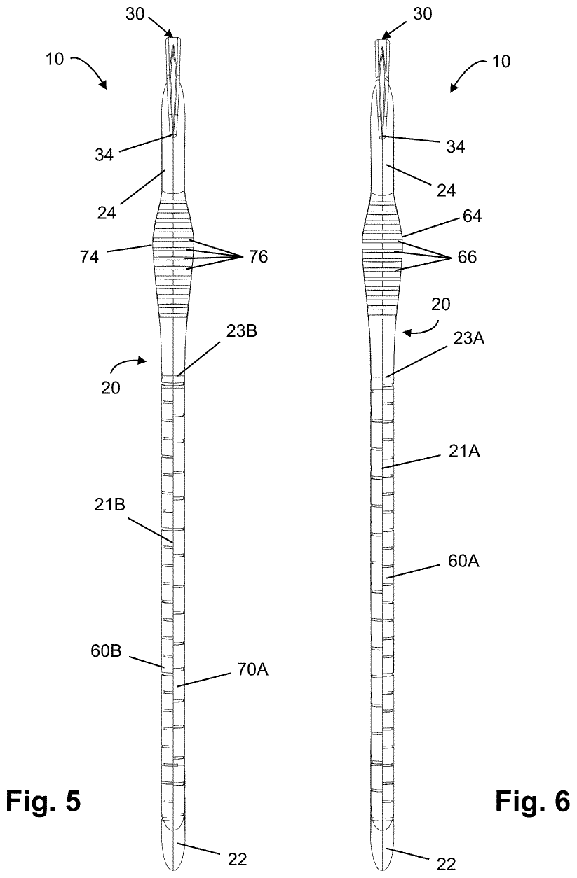

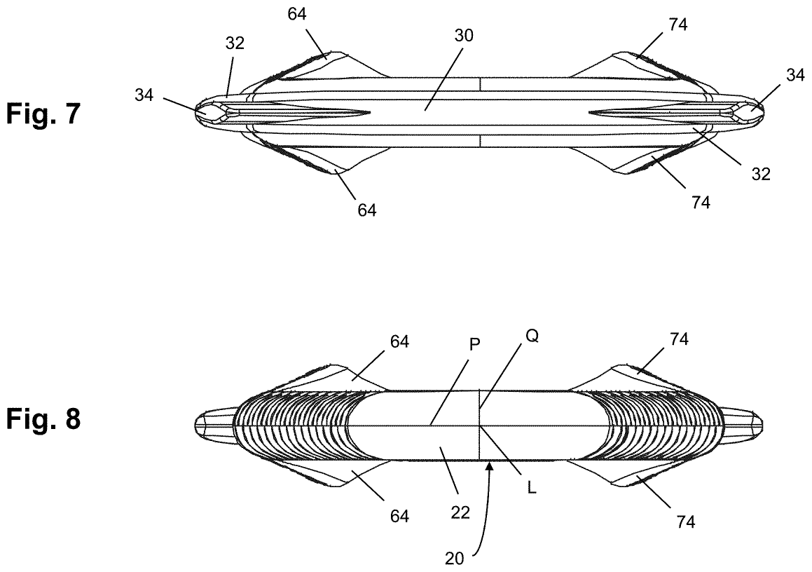

The handle has opposed thumb recesses 62 and 72 which are recessed toward the medial axis of the handle. The recesses are defined by bulging structures 64 and 74 (FIGS. 5, 6) which protrude frontally and rearwardly. The recesses 62 and 72 have a plurality of ribs 66 and 68 to facilitate a thumb grip for the handle. The upper end 24 of the handle has a smooth curvilinear configuration.

The handle has a medial panel construction 25 which extends between the slightly protruding sides 21A and 21B. An aligned series of circular template openings of various diameters 81-86 are formed through the panel. A circular name plate panel 88 is also provided.

The head 30 extends transversely relative to the handle. The head 30 is molded over the blade except for portions of the cutting edge. The head has an arcuate canopy 32 which projects rearwardly and forwardly and extends slightly below the blade on opposed sides of the blade. It will be appreciated that the captured blade 40 includes exposed cutting edge portions 42 and 44 on opposite sides of the upper portions of the handle. The canopy 32 extends to a lid-like protuberance 34 slightly below the exposed portion of the blades to essentially provide a very protective cover for the blade but to allow sufficient exposure so that the blade may be effectively used. The head and handle thus provide restricted access slots 43 and 45 leading to the exposed blade cutting edge portions 42 and 44, respectively.

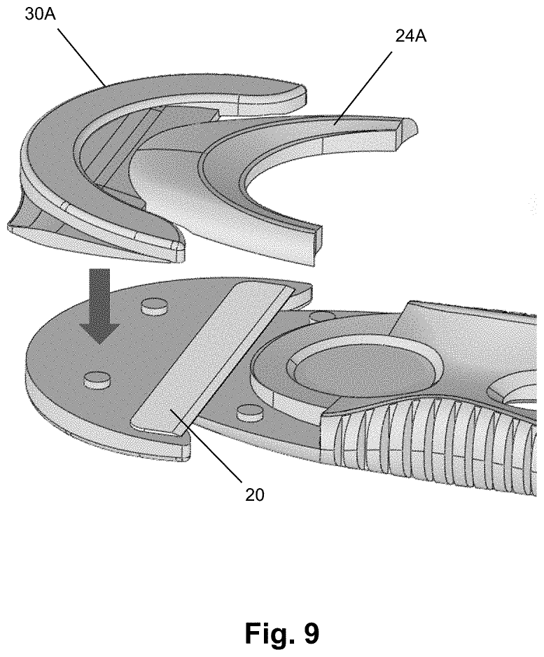

With reference to FIG. 9, a preferred embodiment of the process for manufacturing the safety cutter is illustrated. A frontal portion of the head and neck designated as head 30A and second end 24A, respectively, is initially a separate component. The blade 40, which may be either steel or ceramic, is positioned as illustrated on the remaining portion of the head and handle. The head 30A and second end portion 24A are then ultrasonically welded over and onto the remaining portion of the handle and head to form the integral structure.

The head 30 and the handle 20 are essentially molded over the blade 40, and the blade is effectively secured in a fixed position relative to the handle. The head and handle construction provides for a blade exposure while diminishing any potential blade contact with the person using the blade to thus provide a very safe cutter. The handle may also function as a convenient measuring tool and/or a template for drawing circles of various dimensions.

While preferred embodiments of the foregoing have been set forth for purposes of illustration, the foregoing description should not be deemed a limitation of the invention herein. Accordingly, various modifications, adaptations and alternatives may occur to one skilled in the art without departing from the spirit and the scope of the present invention.

1. A safety cutter comprising:
a handle having a first end and a second end forming a neck and tapering from the first end to an intermediate location and having a reduced portion between said intermediate location and said second end;
a transversely extending head integrally connecting said neck; and
a blade captured by said head wherein portions of said blade are exposed adjacent opposed portions of said neck.

2. The safety cutter of claim 1 wherein said handle and said head are integrally molded components.

3. The safety cutter of claim 1 wherein said handle is generally symmetric about a medial line and has opposed side portions which are generally linear.

4. The safety cutter of claim 3 wherein said handle forms opposed linear side portions and further comprises an English measurement scale disposed along one linear side portion and a metric linear scale disposed along a second linear side portion.

5. The safety cutter of claim 1 wherein said reduced portion has a bulge portion which protrudes frontally and rearwardly.

6. The safety cutter of claim 5 wherein said bulge portion is traversed by a plurality of ribs.

7. The safety cutter of claim 1 wherein said handle further comprises a medial panel portion which extends between opposed sides, and said panel defines a plurality of circular openings.

8. The safety cutter of claim 1 wherein said head has a canopy portion which extends forwardly and rearwardly relative to said blade and covers opposed ends of said blade.

9. The safety cutter of claim 1 wherein said blade is a ceramic blade.

10. A safety cutter comprising:
a handle comprising a first end and a second end forming a neck and tapering exteriorly from the first end to an intermediate location and having a recessed portion between said intermediate location and said second end;
a transversely extending head integrally connecting said neck so that said handle and head form a substantially truncated T-shaped profile; and
a blade captured by said head and said head covering opposed end portions of said blade wherein spaced portions of said blade are exposed adjacent opposed portions of said neck.

11. The safety cutter of claim 10 wherein said handle and said head are integrally molded components.

12. The safety cutter of claim 10 wherein said handle is generally symmetric about a medial line and has opposed side portions which are generally linear.

13. The safety cutter of claim 12 further comprising an English measurement scale and a metric linear scale disposed along each linear side portion.

14. The safety cutter of claim 1 wherein said recessed portion has a bulge portion which protrudes frontally and rearwardly and is traversed by a plurality of ribs.

15. The safety cutter of claim 10 wherein said handle has opposed sides and further comprising a medial panel portion which extends between opposed sides, and said panel defines a plurality of circular openings.

16. A safety cutter comprising:
a handle comprising a first end and a second end and having opposed sides uniformly tapering from the first end to an intermediate location and having a reduced portion between said intermediate location and said second end;
a transversely extending head integrally connecting said handle; and
a blade captured by said head wherein spaced portions of said blade are exposed adjacent opposed portions of said handle and opposed end portions of said blade are covered by said head.

17. The safety cutter of claim 16 wherein said handle and said head are integrally molded components and said handle and head are generally symmetric relative to two central orthogonal planes.

18. The safety cutter of claim 17 wherein opposed side portions are generally linear and further comprising an English measurement scale and a metric measurement scale disposed along a linear side portion.

19. The safety cutter of claim 1 wherein said reduced portion has a bulge portion which protrudes frontally and rearwardly.

20. The safety cutter of claim 16 wherein said head forms are arcuate canopy which extends forwardly and rearwardly and beyond end portions of said blade to define a pair of access slots leading to exposed portions of said blade.
